(19) United States
(12) Patent Application Publication
(10) Pub. No.: US 2010/0214469 A1
(43) Pub. Date: Aug. 26, 2010

(54) SYSTEM, COMPONENTS, AND METHODS FOR VIEWING DOCUMENTS AND OBJECTS USING A WEBCAM

(76) Inventor: Keith Brent Duncan, Norcross, GA (US)

Correspondence Address: GEORGE R. REARDON, 3356 STATION COURT, LAWRENCVILLE, GA, 30044, US

(21) Appl. No.: 12/623,173

(22) Filed: Nov. 20, 2009

Related U.S. Application Data
(60) Provisional application No. 61/208,656, filed on Feb. 26, 2009.

(51) Int. Cl. H04N 5/225; F16M 11/04

(52) U.S. Cl. 348/373; 248/121; 248/125.8; 348/E05.024

(57) ABSTRACT

In various embodiments, systems components, and methods for viewing documents or objects using a webcam are disclosed. In at least one embodiment, a support device is disclosed. The support device includes a stem configured to support an image sensor, a lower projection independently disposed upon a lower end of the stem and configured for coupling to a substantially flat surface, and an upper projection independently disposed upon an upper end of the stem and configured for receipt of an image sensor. In at least one embodiment a system includes the support device an image sensor for capturing images and video, the image sensor repositionably attachable to the support device. In at least one embodiment a method for viewing, capturing, and displaying documents and objects with an image sensor is disclosed.

### CROSS-REFERENCE TO RELATED APPLICATION(S)

The present non-provisional patent application claims the benefit of priority of U.S. Provisional Patent Application No. 61/208,656, which is entitled “SYSTEM, COMPONENTS AND METHODS FOR VIEWING DOCUMENTS AND OBJECTS USING A WEBCAM”, which was filed on Feb. 26, 2009, and which is incorporated in full by reference herein.

### FIELD OF THE INVENTION

The technology described herein relates generally to multi-media communication devices. More specifically, this technology relates to a system, components, and methods for viewing documents or objects using a webcam.

### BACKGROUND OF THE INVENTION

Due to increases in travel costs and the desire for more efficient business processes, there is a need for improved products and methods to conduct meetings between persons located in different locations.

Existing peer-to-peer (P2P) technology allows a remotely located person to review a remotely located computer screen and to allow the people who are participating in the meeting to view each other from a webcam into which the viewers generally speak. However, very often, the people participating in the meeting are discussing details regarding a document or an object. The inability for a remotely located meeting participant to observe that document or object disrupts the feeling of that participant that they are present in the meeting. As a result, the participants can feel disconnected, which decreases the perceived quality and/or effectiveness of remote meetings.

This feeling of “presence” is a central feature affecting the perceived meeting experience of the participants. A “good meeting” may be one where the participants feel that they had a personal connection, and, for many business and personal settings this feeling of connection is deemed critical. The lack of the feeling of presence with existing peer-to-peer technology generally does not supplant the desire to meet in person to conduct business with another person.

Current research indicates that people will be much more willing to forego travel if technology existed that would allow them to feel that they were present with the remotely located meeting participant. “Telepresence” refers generally to a set of technologies which allow a person to feel as if they were present, to give the appearance that they were present, or to have an effect, at a location other than their true location. Telepresence generally requires that the senses of the user, or users, are provided with such stimuli as to give the feeling of being in that other location. Additionally, the user(s) may be given the ability to affect the remote location. In this case, the user's position, movements, actions, voice, etc. may be sensed, transmitted, and duplicated in the remote location to bring about this effect. Therefore, information may be traveling in both directions between the user and the remote location.

Current commercially available telepresence technology is available from Digital Video Enterprises (DVE), Polycom, HP, Cisco, Telanetix, Tandberg, BrightCom, LifeSize, and Teliris. These systems are of varying effectiveness in making a viewer feel as if he was present in the same place as a remotely located meeting participant. Moreover, prices for such systems range from $10,000's to $100,000's. These systems are expensive due to the fact that they include fairly complex arrangements of not inexpensive technology to such as, for example, multiple microphones, speakers, high definition monitors, cameras, and often dedicated networks and custom-made studios. These systems strive to be as transparent to users as possible by providing life-size videos, imperceptible transmission delays, and user-friendly interfaces, facts which likely account for the high cost of these systems.

While existing telepresence systems can be effective in improving the feeling that remotely located meeting participants are present together so as to improve the perceived quality of the meeting, the cost of such systems put them out of reach of many users. Moreover, such systems are generally not transportable, which limits their ability to be widely adopted by more people who might find telepresence useful.

Further, persons who teach or speak often use overhead projectors to enhance the quality of their presentations, such as by displaying documents or objects to their audience. If a person travels to speak and teach, he might find it necessary to transport an overhead projector to the location where he is speaking or teaching. However, existing overhead projectors and digital projectors, although marketed as “portable,” generally are somewhat large. This makes it difficult for someone to easily travel with these devices, especially today when commercial airlines significantly restrict the number of bags that can be carried on board.

There is a need for improved systems, components therefore and methods to conduct meetings, both in person and remotely. The technology described herein addresses these unmet needs.

Related patents and published patent applications known in the background art include the following:

U.S. Pat. No. 5,239,373, issued to Tang, et al. on Aug. 24, 1993, discloses a video computational shared drawing space. The video computational shared drawing space comprises a display unit which displays a composite image; a stylus which is used to “write” on the composite image; a way of detecting the position of the stylus over the composite image; a video camera mounted a short distance away from the video display and aimed at the composite image; a light which provides uniform illumination to the composite image; a mechanism for preventing video feedback; and a computer. A special configuration of cables is used to interconnect the display, the stylus, the position detector, the video camera and the computer. Two or more workstations can be electrically connected to each other via cables or over a network. Many variations of this invention can be created by connecting other components into the computer network. Various combinations of video mixers and video buses can be utilized instead of directly connecting the video cameras to the computers with cables. Three dimensional effects can be created by employing a second video camera, adjacent to the first, in combination with a pair of shuttering spectacles. Images of additional objects can be provided by extra cameras electrically connected in several different ways to the network. To enhance communication between operators separated by large distances, microphones, loudspeakers, auxiliary cameras and auxiliary video displays can be provided at each workstation. Large scale versions of this invention can be constructed. In large scale versions the video display unit is replaced with a large screen and a video projector.

U.S. Pat. No. 5,863,209, issued to Kim on Jan. 26, 1999, discloses an educational image display device. In the image display device, an instructor gives a lecture while seeing an original document without being disturbed by any element of the device. In addition, a video camera, which is detachably attached to the camera mount, may be tilted to the left or right or tilted upward or downward so that it is not required to move the original document when the left, right, upper or lower side of the document has to be picked up by the camera. The above display device also includes a means used as either a whiteboard or an OHP-filmed image revealing panel. The device thus improves educational effect when it is used for educational applications. The device is not expensive thus being widely used for educational applications without forcing excessive costs on the owner.

U.S. Pat. No. D863,209, issued to Roh on Dec. 11, 2001, discloses the ornamental design for a camera for a personal computer.

U.S. Published Patent Application No. 2003/0179313, filed by Mormino, Sr. and published on Sep. 25, 2003, discloses a combined video camera and erasable writing board. Since the camera and erasable board move together, the viewable area remains in focus during motion. The lightweight device is briefcase-transportable and may be used as a “Teleconferencing Pad” or “Video Scratch Pad”. The device accesses the internet via a personal computer, laptop, or other compatible electronic device. Freely available teleconferencing software is available on the internet or may be packaged with the device.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a system, components, and methods for viewing documents or objects using a webcam.

In one exemplary embodiment, the technology described herein provides a support device for an image sensor. The support device includes: a stem configured to support an image sensor; a lower projection independently disposed upon a lower end of the stem and configured for coupling to a substantially flat surface; and an upper projection independently disposed upon an upper end of the stem and configured for receipt of an image sensor.

The lower projection and the upper projection can be oriented in planes substantially parallel to each other.

In at least one embodiment, the stem, lower projection, and upper projection are integrally formed.

The stem is oriented between the upper projection and lower projection at an approximate forty five degree angle to the lower projection when the lower projection is fastened to a substantially flat surface.

An image sensor, such as a webcam, for example, is repositionably attachable to either or both of the stem and the upper projection.

In at least one embodiment, the stem comprises a two-part stem, the two-part stem having a lower stem portion and an upper stem portion. The lower stem portion and the upper stem portion are repositionably attachable to each other at one of a plurality of adjustable lengths.

In at least one embodiment, the lower stem portion and the upper stem portion are repositionably attachable to each other with at least one fastener.

In at least one embodiment, the at least one fastener comprises a pin, and the lower stem portion and the upper stem portion each comprise at least one hole to align and to receive the pin when the lower stem portion and the upper stem portion are coupled together.

In at least one embodiment, the stem is configured to telescope both inwardly and outwardly such that the length of the stem is variably adjustable.

In another exemplary embodiment, the technology described herein provides a system that includes a support device for an image sensor, the support device having a stem configured to support an image sensor; a lower projection independently disposed upon a lower end of the stem and configured for coupling to a substantially flat surface; and an upper projection independently disposed upon an upper end of the stem and configured for receipt of an image sensor; and a first image sensor for capturing images and video, the image sensor repositionably attachable to the support device.

The support device and the first image sensor can be integrally formed in this embodiment.

The system can include a second image sensor, such that the first image sensor is used to face an item to be visually captured, and such that the second image sensor is used to face a presenter.

The first image sensor is repositionably attachable to either or both of the stem and the upper projection.

The first image sensor is configured to transmit a picture or a video to a suitable display unit.

The system can include a fastener configured to rigidly attach the lower projection to the substantially flat surface. In at least one embodiment, the fastener is a clamp.

The system can further include an image display unit configured to display an image or a video captured by the image sensor. The image display unit can be a computer, a smartphone, a personal digital assistant, a television, a projector, a computer monitor, an extended monitor, a video projector, or the like.

The system can further include a personal computer, wherein the image sensor is coupled to the personal computer.

In yet another exemplary embodiment, the technology described herein provides a method for viewing, capturing, and displaying documents and objects with an image sensor. The method includes utilizing a support device for an image sensor comprising: a stem configured to support an image sensor; a lower projection independently disposed upon a lower end of the stem and configured for coupling to a substantially flat surface; and an upper projection independently disposed upon an upper end of the stem and configured for receipt of an image sensor; coupling the lower projection of the support device to the substantially flat surface; utilizing an image sensor for capturing images and video; attaching the image sensor to the support device; and capturing an image with the image sensor.

The method can also include transmitting a picture or a video to a suitable display unit; and displaying the picture or the video on the suitable display unit.

The method can further include orienting the stem between the upper projection and lower projection at an approximate forty five degree angle to the lower projection when the lower projection is fastened to a substantially flat surface.

Advantageously, the system, device, and methods disclosed herein provide an improvement in the ability of a remote viewer to feel as if he is present with a person holding a meeting in a different location. In particular, the system allows a speaker to speak directly to a remote viewer while at the same time showing the remote viewer different perspectives, such as a document or object being discussed. The present system has been found to be particularly useful for remote teaching activities and demonstrating products or items for sale remotely. Further, the system can allow edits and corrections to documents or the marking of objects to be made in real time and in the presence of witnesses (either viewing in the same room or remotely) so as to improve authentication of same at a later date.

Also advantageously, the system, device, and methods disclosed herein provide portability. Unlike traditional overhead projectors, the system includes very few parts and is very lightweight. For transport the support device can be fully separated from the webcam to allow these aspects of the system to fit within a briefcase or other portable carrying device. The system of therefore provides an efficient and versatile system to capture and store pictures and videos.

Further advantageously, the system, device, and methods disclosed herein provide for rapid set up of the system for use. Specifically, the webcam is quickly repositionably attachable to the support device using the methods described elsewhere herein. The webcam then needed only be attached to a display unit to allow the user to capture pictures or videos for transmission to a viewer.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the technology described herein. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a schematic diagram of a system for viewing documents or objects using a webcam, according to an embodiment of the technology described herein;

FIG. 2 is a front perspective view of the system and components for viewing documents or objects using a webcam, according to an embodiment of the technology described herein;

FIG. 3 is a front perspective view of the system and components for viewing documents or objects using a webcam depicted in FIG. 2, illustrating, in particular, placement of the stem assembly and webcam above a document and the rotation of the webcam, according to an embodiment of the technology described herein;

FIG. 4 is a front perspective view of a telescopic stem assembly for use with a webcam for viewing documents or objects, according to an embodiment of the technology described herein;

FIG. 5 is an expanded view of the system components, illustrating, in particular, the stem assembly, webcam, and clamp, according to an embodiment of the technology described herein;

FIG. 6 is a perspective view of an integrally formed stem, according to an embodiment of the technology described herein;

FIG. 7 is a perspective view of a telescopic stem assembly, according to an embodiment of the technology described herein; and

FIG. 8 is a perspective view of a stem assembly, maintained in place by a pin, according to an embodiment of the technology described herein.

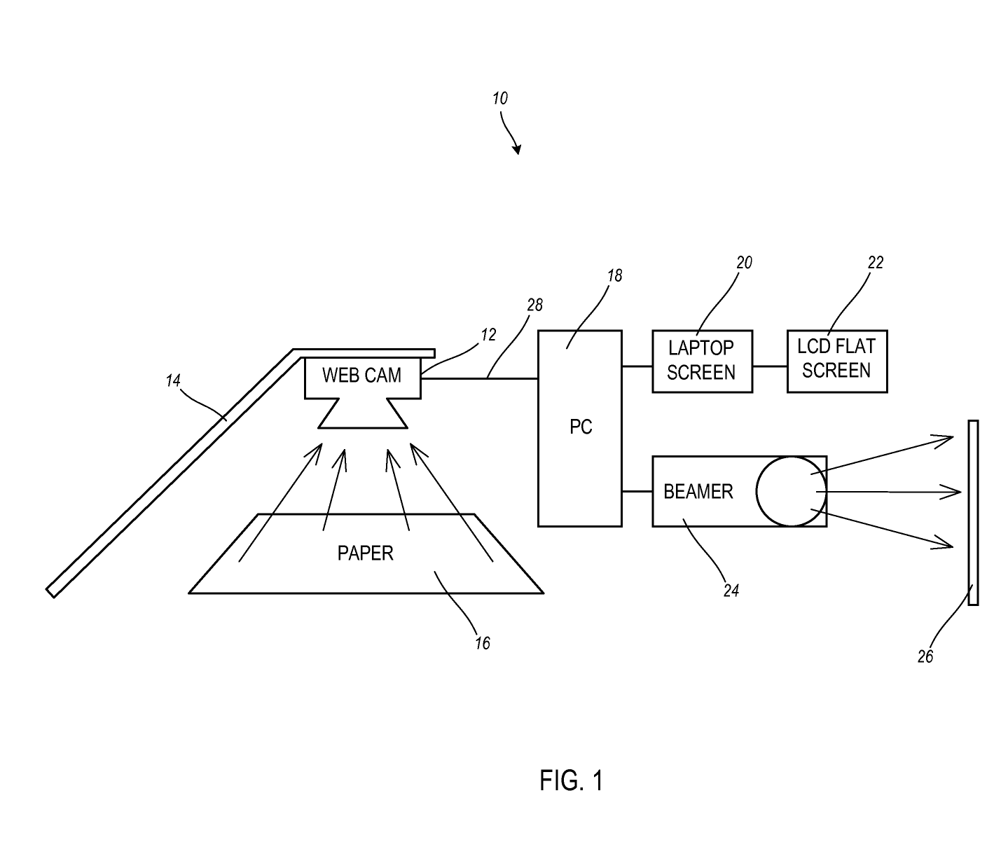

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

Referring now to the Figures, in various exemplary embodiments, the technology described herein provides a system 10, components, and methods for viewing documents 16 or objects using a webcam 12. The system is small, lightweight, portable, and easy to mass manufacture with minimal moving parts. The system 10 is configured to be assembled very rapidly, typically in less than fifteen seconds.

A “webcam” 12 is a video camera connected to a computer 18 or other suitable device so that its output may be viewed, either directly on a display unit or transmitted over the Internet, cellular telephone, etc. Additionally, other types of picture and video capture devices, whether existing today or developed in the future, are suitably used as a component in the system 10 disclosed herein, as long as such picture or video capture device is capable of being repositionably attached to the support device 14 disclosed herein and is also capable of transmitting pictures or videos to display unit as defined elsewhere herein. To be suitable for use, the video or picture capture device, i.e., the webcam 12 (as the term is defined herein), has the ability to provide the picture or video in digital form (either directly or through conversion) to a display unit suitable for viewing the picture or video.

“Display unit” means the device upon which a viewer observes the video or pictures captured by the webcam 12 used in the system 10 of the technology described herein, such as for example, a laptop screen 20, LCD flat screen 22, or projector screen 26. The display unit can be, for example, a computer, digital projector 24, Smartphone, PDA, television, computer monitor, extended monitor, video projector, and the like, configured to accept a video or picture signal captured by the webcam 12 via a wired 28, e.g. USB, such as 48, or the like or a wireless connection.

In relation to the support device 14 used to support the webcam 12 during use, “repositionably attached” or “repositionably attachable” means that the webcam 12 can be attached and reattached to the support device 14 as needed and desired by the user.

“Remotely located viewer” means a viewer who views a video or picture captured by a webcam 12, where the picture or video is transmitted by signal to viewer in another location from the person conducting the meeting. When a remote viewer is attending a meeting, the signal from the webcam 12 is transmitted via the Internet or by device suitable to transmit a picture and/or video from the webcam. Examples of such suitable transmission devices can comprise, in non-limiting examples, a PDA e.g. I-Phone® or a Blackberry®, or a Smartphone.

In one aspect, the technology described herein comprises a system 10 for capturing video and/or pictures of documents, objects or the like using a webcam, as this term is defined elsewhere herein. In pertinent part, the system 10 comprises a support device 14, wherein the support device 14 allows repositionable attachment of the webcam 12 thereto. The system 10 can also comprise a display unit, such as screens 20, 22, 26 for example, capable of accepting videos and/or picture signals from the webcam.

A significant feature of the technology disclosed herein is that the system 10 allows anything placed within the visual frame of the webcam 12 to be transmitted either to an in-person audience or to a remote viewer substantially in real time and/or captured for later viewing.

In one aspect, the technology described herein can be used to facilitate in person meetings—that is, when a speaker is in the same room as the audience—by allowing a speaker to easily show documents, such as paper 16, or objects to an audience in real time. In such an aspect, the technology described herein provides a highly portable and flexible substitute for a traditional overhead projector system. Specifically, unlike traditional overhead projector systems, the system 10 of the technology described herein typically weighs less than about one pound and can be set up for use very quickly. Moreover, unlike traditional overhead projectors, the system 10 of the technology described herein allows video and pictures to be captured for later review.

In a particularly useful aspect of the technology described herein, writings or edits made by hand can be made to a document or permanent markings can be made to an object, where such writings, edits and markings can be viewed substantially in real time by the audience. The ability of a group to view such activities improves the ability of others to verify that the document or object is an authentic version thereof at a later time. As one example of this aspect, edits can be made to a contract to be viewed by a group in a meeting setting, and those changes can be verified later through review of a video capture of the edits. Still further, in an auction setting, an object can be marked such as by the auctioneer to demonstrate to a group that a buyer purchased that particular object. The buyer can later authenticate the identity of the object by comparing the marking made as shown in the video with the marking on the actual object. In yet a further example, Bible study can be conducted in a group setting to demonstrate to an audience the place in the Bible from which the study leader is reading. This can be recorded for later playback.

To operate in the facilitation of in person meetings, the videos and/or pictures captured from the webcam 12 that is repositionably attached to the support device 14 can be transmitted via wired 28 or wireless connection to, for example, a computer 18, PDA, Smartphone or digital projector 24 for viewing by the audience. The videos and/or pictures can be viewed in real time or can be recorded (or otherwise “time shifted”) for playback at a later time.

The software used to transmit captured video or pictures from the webcam 12 repositionably mounted on the support device 14 to the display unit e.g. computer 18, PDA, Smartphone, television or digital projector 24, is not currently believed to be critical to the technology described herein. As such, when the webcam 12 is repositionably mounted on the support device 14 the software provided with the webcam 12 to allow capture or display of the captured pictures or video can suitably be used.

In a further aspect, the technology described herein facilitates meetings where at least two of the participants therewith are located in different locations. In this case a remote viewer is able to see a document or object in real time as that document or object is, for example, discussed, marked or edited by someone present therewith. The system 10 of the technology described herein is highly flexible and can be used to capture images for transmission to remote user or captured for later review such as, almost any document form and size, book, contract or notes. In a particularly useful aspect of the technology described herein, notations can be transmitted to a remote viewer in substantially real time or captured for later viewing.

In a pertinent example of this aspect of the system 10 of the technology described herein, edits to drawings can be captured by the webcam 12 and transmitted to a remote user in substantially real time or captured for later viewing. In a further pertinent example, brainstorming can occur between participants in different locations. The flexibility of the system 10 of the technology described herein allows such remotely located users to both take notation and directly communicate with the other participants.

To allow a remote viewer to observe a document or object while being discussed or described by a speaker in another location, standard peer-to-peer meeting software can be used to transmit the captured video or pictures. Such software includes branded products such as WebEx® (owned by Cisco Corporation), Go to Meeting® (owned by Citrix) and Skype®. When the system 10 is used for a remote meeting, software that allows a user to view split or dual screens can provide tremendous benefits because a presenter can show a document 16 or object while still maintaining a conversation with a viewer located away from the presenter. For example, the presenter can orient him or herself to one webcam 12 while at the same time capturing a picture or video with the webcam repositionably attached to the support device 14. As one example, a teacher can provide real time edits to a student's class assignments while the student watches from a remote location by using the webcam 12 repositionably attached to the support device 14 while at the same time the teacher is speaking directly to the student through a second webcam 12 positioned at eyelevel.

Still further, the system 10 of the technology described herein can be used to demonstrate aspects of an object to a remote viewer or captured for later viewing. For example, a remote viewer can be shown aspects of an object for purchase. As one example of this aspect, a merchant can show a remote purchaser a product using the system 10. For products having unique features, such as antiques, art, coins or the like, the seller can identify the object using some sort of security device while the purchaser is watching in real time, such as a seal or signature etc. When the purchaser receives the object, he can compare the security feature captured using the system 10 of the technology described herein with the security feature present on the product as received. This provides the purchaser with proof that the product received is the actual product requested from the remote seller.

In one aspect, the support device 14 permits repositionable attachment of a webcam 12 thereon, where the support device 14 and webcam 12 comprise a significant aspect of the system 10. Significantly, the support device 14 allows the webcam 12 to be repositionably attached so as to substantially prevent environmental sources of vibration from being transmitted to the webcam 12. It should be noted that many webcams 12 (as well as other modern video capture devices) include software that provides digital picture stabilization to reduce or eliminate shaking of the picture when viewed. The stabilization provided by the support device 14 of the system 10 of the technology described herein is distinguishable from such software-derived picture stabilization. In other words, the webcam 12 attached to the support device 14 of the technology described herein is isolated or substantially isolated from environmental sources of vibration due to the shape and composition of the support device 14 and the way the webcam 12 is attached to the support device 12. The technology described herein therefore allows stable viewing of a picture or video from a webcam 12 even if digital picture stabilization is absent or substantially absent from the webcam 12 or other picture or video capture device.

The support device 14 of the system 10 of the technology described herein can be prepared from metal, plastic or any other suitable material. Since the support device 14 is intended to easily transportable by a user, it can be desirable to prepare the support device 14 out of a lightweight material. If metal is used, the support device 14 can be suitably prepared out of aluminum or other lightweight metal. If plastic is used to prepare the support device 14, the plastic should be strong and rigid enough to support a webcam 12 thereon. Moreover, regardless of the material used to prepare the support device 14, the device should be fabricated so as to substantially prevent environmental sources of vibration from being transmitted from the surface upon which the support device 14 is mounted to the webcam 12. This feature of the support device 14 can significantly improve the functionality of the system because the webcam is effectively isolated from any vibration in the environment.

In one aspect, the support device 14 can comprise an approximately z-shaped (whether oriented correctly or in reverse) structure fabricated out of suitable material (as discussed elsewhere herein), wherein the structure comprises an upper projection 52 and a lower projection 50, wherein the upper and lower projections 52, 50 are each joined at one end to a stem 54. The upper and lower projections 52, 50 can be oriented as depicted in the Figures.

Moreover, the orientation of the upper and lower projections 52, 50 of the support device 14 in relation to each other and each to the stem 54 also comprises a notable aspect of some aspects of the technology described herein. The inventor has found that when the lower projection 50 is substantially flat against a substantially flat surface, a webcam 12 attached to the support device 14 having a stem 54 oriented at an approximate 45 degree angle to the lower projection 50 provides substantial flexibility in use. The upper and lower projections 52, 50 can each, independently, be oriented in a bent, offset or twisted orientation in relation to the stem 54. Specifically, the approximate 45 degree angle allows the webcam 12 to be moved along the stem 54 at substantially any location and still be oriented to allow the webcam 12 to be used to visualize both large and small documents and objects.

In a further aspect, the stem 54, and consequently the distance by which the upper and lower projections 52, 50 are separated, can be of any suitable length to allow capture of pictures or video using a webcam repositionably attached thereto. For example, when viewing large documents 16 (such as schematics or architectural drawings), a longer stem 54 can allow visualization of the entire document 16 in a single visual frame. Similarly, a shorter stem 54 can allow visualization of a smaller document in a single visual frame. If a longer stem 54 is used, a webcam 12 repositionably attached to the stem 54 can be virtually infinitely repositioned along the length of the stem 54 to allow pictures and videos of documents and objects of various sizes without separately adjusting the focus or orientation of the webcam 12. This allows the user to focus on his or her conversation or presentation with the remote viewer, rather than needing to repeatedly refocus the camera 12 to obtain a clearer or close-up picture.

Yet further, the support device 14 can be disassembled to improve the portability of the system 10 of the technology described herein. To this end, the stem 54 can be comprised of at least two separate parts, such as a lower stem 38 and an upper stem 40, that are connected by as fastener. Examples of suitable fasteners include, for example, a screw or a cotter pin 44 or the like. Pin 42 can be grasped by ring 46 and placed through pin hole 44 to secure the lower stem 38 and the upper stem 40 one to another. As such a telescoping effect is created, as shown, for example, by telescoping direction 36, as depicted specifically in FIG. 4. For storage and transport, the at least two parts 38, 40 of the stem 54 can be rotated on an axis (such as that resulting from a circular connector substantially permanently attaching the at least two parts) so that the at least two parts 38, 40 of the stem 54 substantially nest so as to reduce the overall length of the stem 54. For use, the at least two parts 38, 40 of the stem 54 can be rotated on the axis and fastened or locked to provide an assembled support device 14 comprising the at least two parts.

In a further method to permit disassembly the support device 14 to improve portability, a groove or pin hole 44 can be present in one or more of the at least two parts 38, 40 of the support device 14. One or more screws or other type of fastener 42 can be used to assemble the at least two parts 38, 40 of the support device 14. The support device 14 can be lengthened and shortened for use and portability by re-positioning the location of the fastener 42 as appropriate.

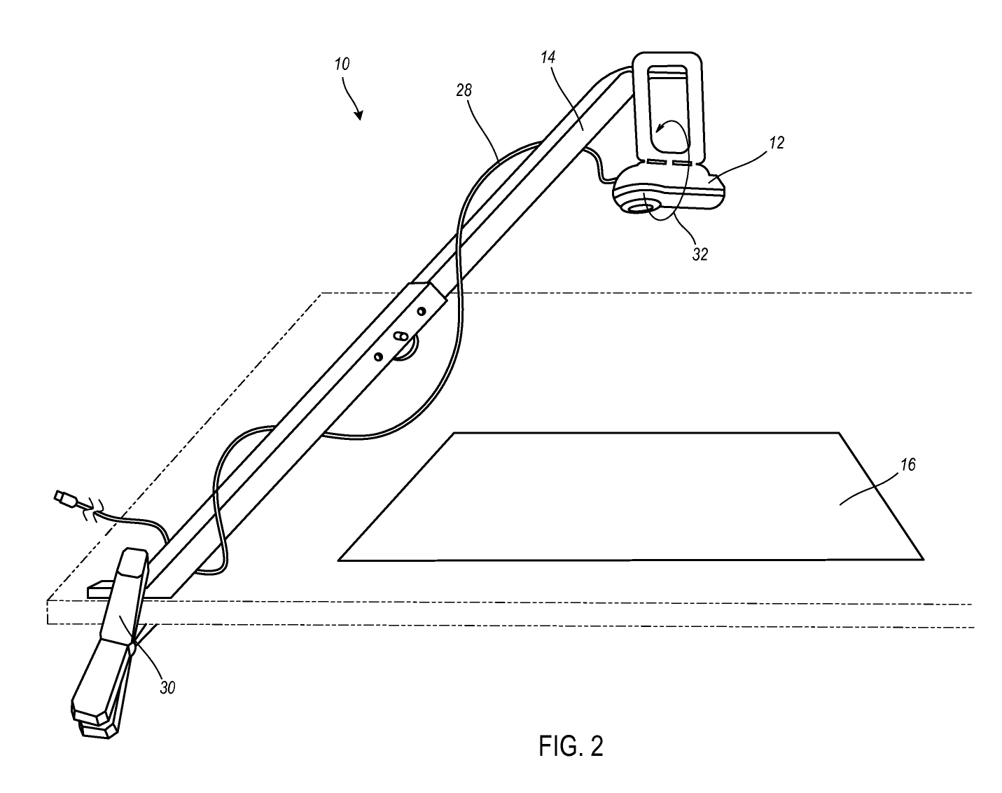

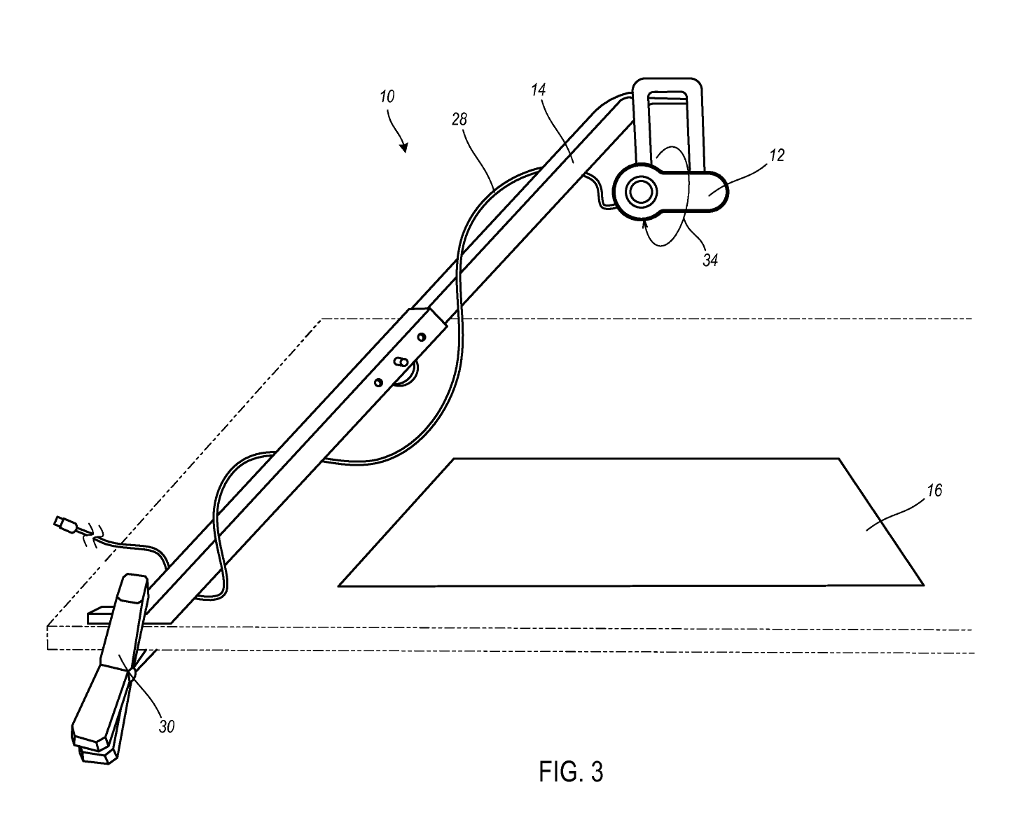

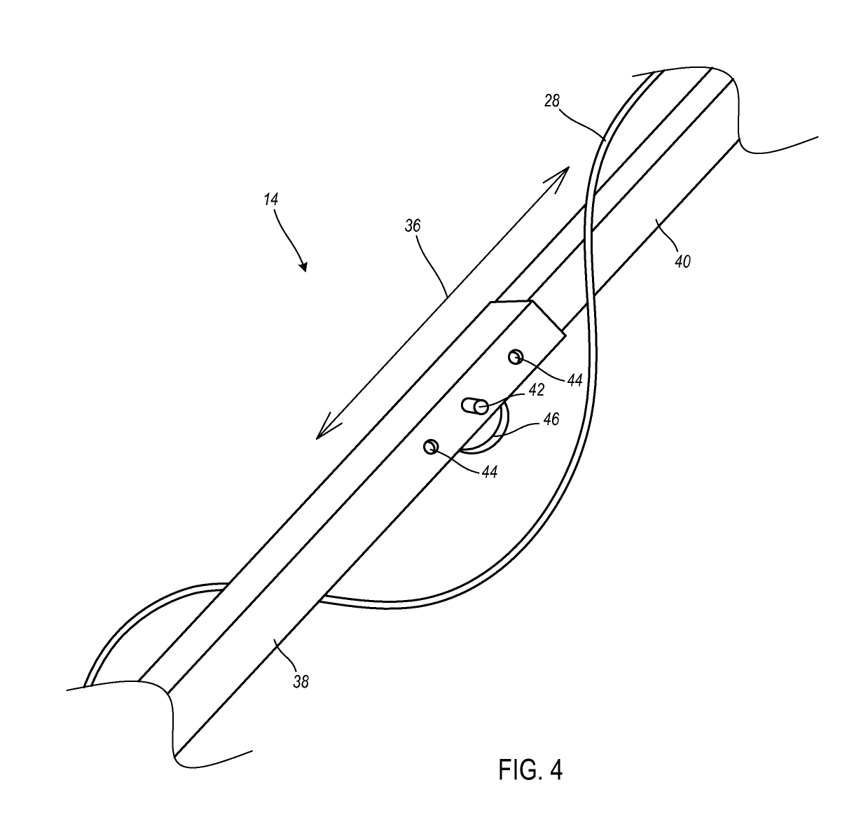

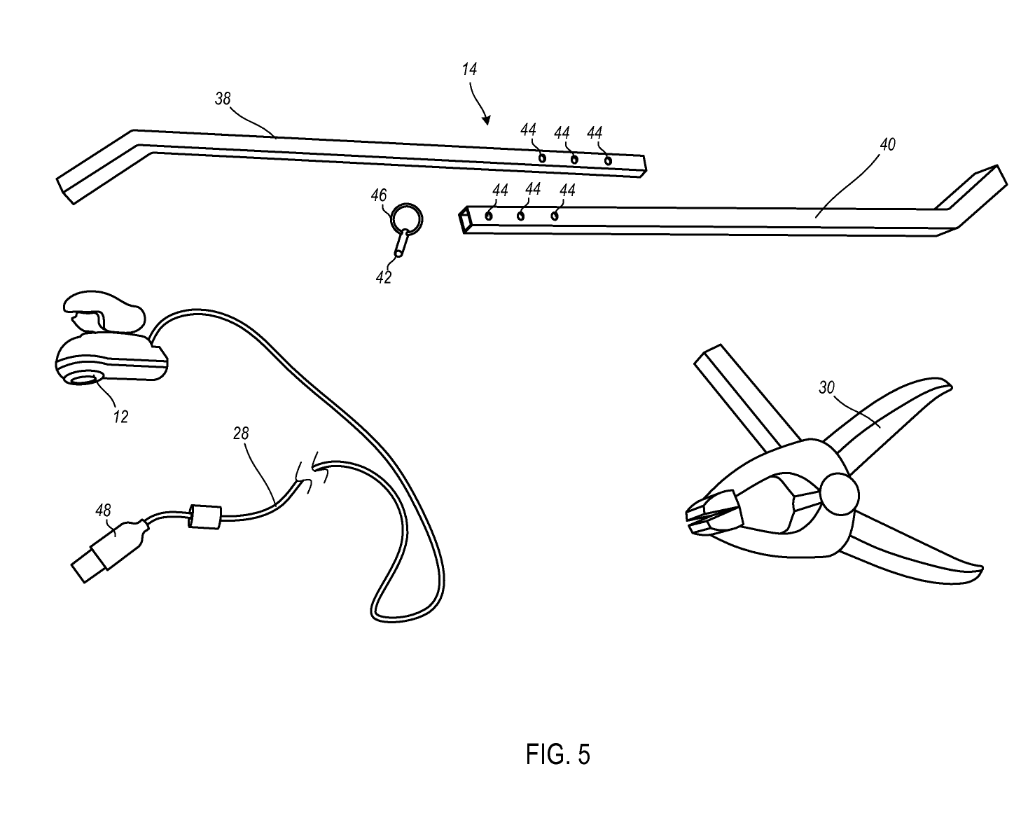

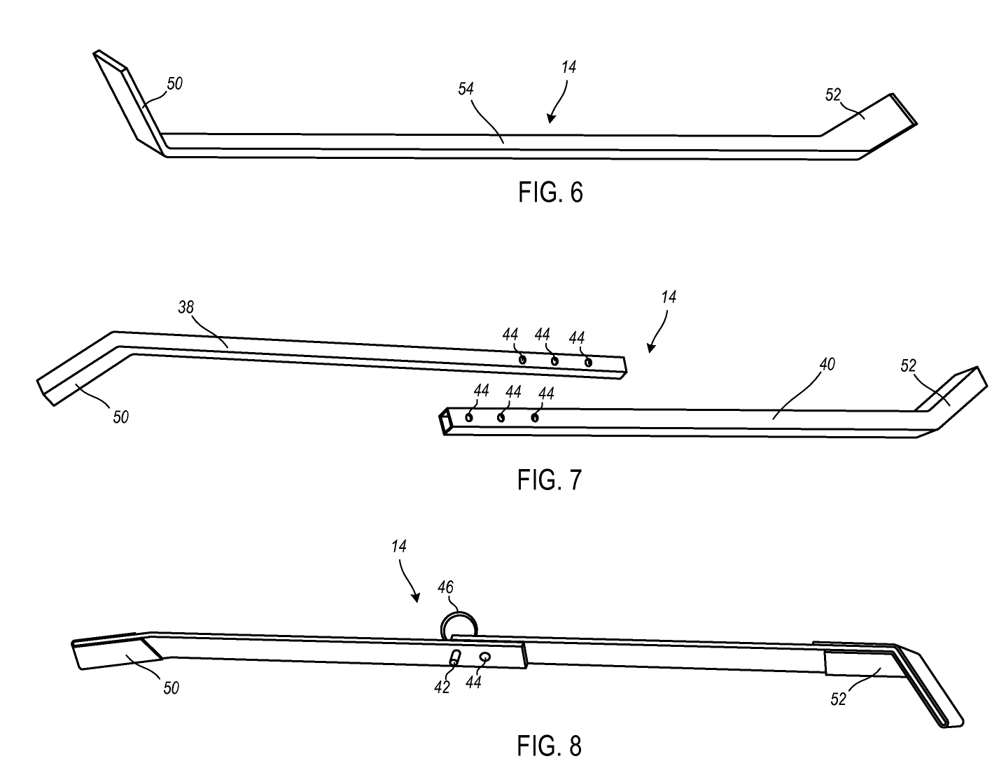

In a significant aspect, when the webcam 12 is repositionably attached to the support device 14, the user is able to rotate the webcam 12 substantially throughout a 360 degree orientation without dismounting the webcam 12 from the support device 14. Rotation can include, for example, rotation in direction 32, as depicted in FIG. 2. Similarly, rotation can include, for example, rotation in direction 34, as depicted in FIG. 3. Moreover, such rotation can occur substantially without distortion of the picture quality because the lower projection allows the webcam 12 to effectively glide smoothly along a substantially flat surface such as a table or lectern. The substantial non-distortion is accomplished as a result of the orientation of the support device 14 having the webcam 12 repositionably attached with the surface upon which the support device 14 is situated.

The webcam 12 can be repositionably attached to the support device 14 using one or more attachment methods. Repositionable attachment of the webcam 12 to the support device can be accomplished using a hook and eye system e.g. Velcro® wherein the hook part is securely attached to the stem and upper projection of the support device and the eye part is securely attached to the webcam (or vice versa). Additionally, the stem 54 and upper projection 52 of the support device 14 can be configured to allow the webcam 12 to be attached by inclusion of repositionable attachment directly onto the support device 14. For example, the webcam 12 can be configured with a magnetized aspect to allow repositionable attachment to the stem 54 and upper projection 52. Still further, the stem 54 and upper projection 52 can include grove functionality and the webcam 12 can include tongue functionality (or vice versa) so that the webcam 12 can be moved along the surface of the support device 14 to allow the webcam 12 to be repositionably attached thereto. Yet further, the upper projection 52 and stem 54 can be configured in any manner that allows the webcam 12 to be repositionably attached thereto.

The support device 14 (whether or not the stem 54 is comprised of one part or at least two parts) can comprise the repositionable attachment e.g., Velcro, along the entire length or along only a part of the length of the stem 54. For example, when the stem 54 comprises two parts rotatable on an axis, the repositionable attachment can be included substantially on one part of the stem 54. In such an aspect, the repositionable attachment may extend along a top side, a lower side or both of the upper projection 52 to permit the webcam 12 to be mounted thereon to provide enhanced viewing range in use.

In a further aspect, the support device 14 (whether or not the stem is comprised of one part or at least two parts) can include the repositionable attachment on an upper and lower side of the stem 54. For example, when the stem 54 comprises at two parts 38, 40, the upper part 40 of the stem 54 can include Velcro along its upper length and continuing to the top side of the upper projection 52. The Velcro can also be present on the bottom side of the lower projection 50 and, optionally, continuing down the bottom side (that is the side facing away from the other side) of the first part of the two part stem.

In use, the support device 14 having a webcam 12 repositionably attachable thereto is itself attached to a substantially flat surface, such as a table or lectern or other suitable surface, using a clamp 30 or any other suitable fastener. The method of fastening the support device 14 to a substantially flat surface is not currently believed to be significant to the operation of the technology described herein. However, in order to suitably isolate the webcam 12 from environmental vibration so as to provide a substantially distortion free picture or video, the support device 14 should be substantially rigidly fastenable to the substantially flat surface. In other words, loose fastening of the support device 14 to a table, lectern or other mounting surface will make it more likely that environmental sources of vibration will be transmitted to the webcam 12, which could decrease the quality of the picture or video obtained from the webcam 12.

Without being bound by theory, the inventor herein believes that the angle and orientation of the support device 14 effectively assist in dissipating environmental vibrations before such vibrations can reach the webcam 12. Accordingly, it is currently understood that the support device 14 allows the webcam 12 to capture videos and/or pictures without substantial distortion thereof, where such lack of distortion is substantially independent of any anti-distortion software associated either with the webcam 12 or an attendant display unit.

A further component of the system 10 of the technology described herein is a webcam 12 or other device that can capture or transmit pictures or video depictions of objects as defined elsewhere herein. While a webcam 12 today comprises a highly suitable device for use in the system 10, it is expected that other devices will be useable with the technology described herein. The device used to capture a picture or video of the object is not believed to be critical to the functionality of the technology, as long as the device can be suitably repositionably attached to the support device. When a webcam 12 is used, high resolution devices typically are beneficial. Webcam 12 technology is improving rapidly, as such it is expected the suitable webcams (as well as other devices) will change substantially in the not-too-distant future. However, at the present time, a highly suitable webcam 12 for use as a component in the system 10 is made by Logitech under the 9000 Pro brand.

If the webcam 12 comprises a wired connection to transmit the pictures or video, the support device 14 can be configured to allow suitable concealment or containment of the cord to assist in ease of use of the system 10. Such concealment or containment can be by clips or other type of fastener, or the support device 14 can comprise a way to allow the cord 28 to be integrated into the support device 14 itself The system 10 of the technology described herein shows particular utility wherever an overhead projector or digital projector can be used. Moreover, the system 10 can also be used to as a highly portable document scanner. Still further, the system 10 can be used to improve the quality of remote meetings. In such aspect, the person conducting the meeting can speak directly to the remote viewer using the one webcam 12 (such as the webcam 12 embedded within or attached to the computer 18) while using the system 10 to display documents or objects in a separate window. The system 10 therefore allows the feeling enhanced engagement of remote viewers with the person conducting the meeting and the information that is being discussed therein. Significantly, the improved meeting quality is possible at substantially less expense than currently available with telepresence technology existing today.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the technology described herein and are intended to be covered by the following claims.

What is claimed is:

1. A support device for an image sensor, the support device comprising:
a stem configured to support an image sensor;
a lower projection independently disposed upon a lower end of the stem and configured for coupling to a substantially flat surface; and
an upper projection independently disposed upon an upper end of the stem and configured for receipt of an image sensor.

2. The support device of claim 1, wherein the lower projection and the upper projection are oriented in planes substantially parallel to each other.

3. The support device of claim 1, wherein the stem, lower projection, and upper projection are integrally formed.

4. The support device of claim 1, wherein the stem is oriented between the upper projection and lower projection at an approximate forty five degree angle to the lower projection when the lower projection is fastened to a substantially flat surface.

5. The support device of claim 1, wherein an image sensor is repositionably attachable to either or both of the stem and the upper projection.

6. The support device of claim 1, wherein the stem comprises a two-part stem, the two-part stem having a lower stem portion and an upper stem portion, and wherein the lower stem portion and the upper stem portion are repositionably attachable to each other at one of a plurality of adjustable lengths.

7. The support device of claim 6, wherein the lower stem portion and the upper stem portion are repositionably attachable to each other with at least one fastener.

8. The support device of claim 7, wherein the at least one fastener comprises a pin, and wherein the lower stem portion and the upper stem portion each comprise at least one hole to align and to receive the pin when the lower stem portion and the upper stem portion are coupled together.

9. The support device of claim 7, wherein the stem is configured to telescope both inwardly and outwardly such that the length of the stem is variably adjustable.

10. A system comprising:
a support device for an image sensor comprising:
a stem configured to support an image sensor;
a lower projection independently disposed upon a lower end of the stem and configured for coupling to a substantially flat surface; and
an upper projection independently disposed upon an upper end of the stem and configured for receipt of an image sensor; and
a first image sensor for capturing images and video, the image sensor repositionably attachable to the support device.

11. The system of claim 10, wherein the support device and the first image sensor are integrally formed.

12. The system of claim 10, further comprising:
a second image sensor, such that the first image sensor is used to face an item to be visually captured, and such that the second image sensor is used to face a presenter.

13. The system of claim 10, wherein the first image sensor is repositionably attachable to either or both of the stem and the upper projection.

14. The system of claim 10, wherein the first image sensor is configured to transmit a picture or a video to a suitable display unit.

15. The system of claim 10, further comprising:
a fastener configured to rigidly attach the lower projection to the substantially flat surface.

16. The system of claim 15, wherein the fastener is a clamp.

17. The system of claim 10, further comprising an image display unit configured to display an image or a video captured by the image sensor.

18. The system of claim 17, wherein the image display unit comprises one taken from the list consisting of: a computer, a smartphone, a personal digital assistant, a television, a projector, a computer monitor, an extended monitor, and a video projector.

19. The system of claim 10, further comprising:
a personal computer;
wherein the image sensor is coupled to the personal computer.

20. A method for viewing, capturing, and displaying documents and objects with an image sensor, the method comprising:
utilizing a support device for an image sensor comprising: a stem configured to support an image sensor; a lower projection independently disposed upon a lower end of the stem and configured for coupling to a substantially flat surface; and an upper projection independently disposed upon an upper end of the stem and configured for receipt of an image sensor;
coupling the lower projection of the support device to the substantially flat surface;
utilizing an image sensor for capturing images and video;
attaching the image sensor to the support device; and
capturing an image with the image sensor.

21. The method of claim 20, further comprising:
transmitting a picture or a video to a suitable display unit; and
displaying the picture or the video on the suitable display unit.

22. The method of claim 20, further comprising:
orienting the stem between the upper projection and lower projection at an approximate forty five degree angle to the lower projection when the lower projection is fastened to a substantially flat surface.
